(19) United States
(12) Patent Application Publication
(10) Pub. No.: US 2004/0048523 A1
(43) Pub. Date: Mar. 11, 2004

(54) High elasticity contact for electrical connector and contact carrier

(76) Inventors: Chieh Rung Huang, Tu-Chen (TW); Ming-Lun Szu, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/377,942

(22) Filed: Feb. 28, 2003

(30) Foreign Application Priority Data
Sep. 9, 2002 (TW) 91214022

(51) Int. Cl. H01R 4/48

(52) U.S. Cl. 439/862

(57) ABSTRACT

An electrical contact (1) used in a connector includes a medial portion (10), a cantilever (12) extending from a top end of the medial portion, and a solder portion (14) adapted to connect with a printed circuit board (5) extending from an opposite bottom end of the medial portion. The cantilever includes a vertical body portion (121), and an arm portion (120) extending obliquely from a distal end of the body portion away from the medial portion. An obtuse angle (α) is defined between the medial portion and the arm portion. An arcuate contact portion (122) is defined at a distal end of the arm portion, for electrically connecting with an electrical package (3). When the contact is connected to the electrical package, the body portion and the arm portion cooperatively elastically deform, thus providing the contact with excellent elasticity.

### BACKGROUND OF THE INVENTION

1. Field of the Invention

The present invention relates to contacts used in an electrical connector adapted to connect a printed circuit board (PCB) with an electrical package.

2. Description of the Prior Art

The size of electrical connectors used in computers is becoming steadily smaller. Such connectors essentially comprise a housing and a plurality of contacts received in the housing. Yet the contacts of the connector need to have long elastically deformable arms, in order to ensure reliable electrical connection between the connector and an electrical package mounted on the connector. A typical such connector is disclosed in Taiwan Patent Publication No. 444960. Referring to FIGS. 6 and 7, the connector comprises a base 8 defining a plurality of passageways 80 adapted to receive corresponding contacts (not shown). Each row of passageways 80 defines a line forming an angle of 45 degrees relative to the sidewall 82 of the connector. This configuration provides each passageway 80 with sufficient space to receive a contact having long elastic arms. However, limited by the present manufacturing technology, this arrangement mode is not appropriate to receive the contacts arrayed in rows or columns correctly at the same time. In addition, as each row of the passageway 80 inclines an angle to the sidewalls 82, the manufacturing matrix must be designed as the same structure, which obviously increase the difficulty of manufacturing.

FIG. 8 shows a conventional contact 60 for receiving a pin of an electrical package. FIG. 9 shows a plurality of preforms of the contact 60 connected with a carrier strip 70. The carrier strip 70 is stamped from conductive metallic material, and comprises an operation carrier 66, a plurality of connecting portions 65 extending from one side of the operation carrier 66, and a plurality of contacts 60 extending from respective connecting portions 65. Each contact 60 comprises a medial portion 61, a solder portion 64 extending from one end of the medial portion 61, and a spring portion 63 extending from an opposite end of the medial portion 61. A plurality of barbs 611 is formed on opposite side edges of the medial portion 61, for interferentially fastening the contact 60 in a corresponding passageway of an electrical connector (not shown). The spring portion 63 is relatively long, providing it with good elasticity. However, in the carrier strip 70, the spring portions 63 of the performs are parallel to the operation carrier 66. Thus spaces between preforms are unduly large. This leads to wastage of the conductive metallic material, which increases manufacturing costs.

Hence, a new contact which overcomes the above-described disadvantages is desired.

### SUMMARY OF THE INVENTION

An object of the present invention is to provide an electrical contact which has high elasticity.

Another object of the present invention is to provide an electrical connector which enables reliable connection between two electrical connectors or two electrical packages.

A further object of the present invention is to provide a carrier strip configured to efficiently contain adjacent electrical contacts having high elasticity.

In order to achieve the first abovementioned object, an electrical contact used in a connector in accordance with a preferred embodiment of the present invention comprises a medial portion, a cantilever extending from a top end of the medial portion, and a solder portion adapted to connect with a PCB extending from an opposite bottom end of the medial portion. The cantilever comprises a vertical body portion, and an arm portion extending obliquely from a distal end of the body portion away from the medial portion. An obtuse angle is defined between the medial portion and the arm portion. An arcuate contact portion is defined at a distal end of the arm portion, for electrically connecting with a conductive pad of the electrical package. When the contact is connected to the electrical package, the body portion and the arm portion cooperatively elastically deform thus providing the contact with excellent elasticity.

In order to achieve the second abovementioned object, a related ball grid array (BGA) connector in accordance with a preferred embodiment of the present invention comprises an insulative housing and a plurality of the above-described contacts received in the housing.

In order to achieve the third abovementioned object, a carrier strip in accordance with a preferred embodiment of the present invention comprises an operation carrier connected with a series of preforms of the above-described contacts. The arm portion of each perform extends beyond a distal end of the body portion of an adjacent perform. In addition, the arm portions of adjacent preforms are substantially parallel to each other. Thus the arm portions of the preforms can be configured to any suitable length to provide desired elasticity thereof.

Other objects, advantages and novel features of the present invention will become more apparent from the following detailed description when taken in conjunction with the accompanying drawings.

### BRIEF DESCRIPTION OF THE DRAWINGS

FIG. 1 is an isometric view of a contact for an electrical connector in accordance with a preferred embodiment of the present invention.

FIG. 2 is a top elevation view of an operation carrier in accordance with a preferred embodiment of the present invention.

FIG. 3 is a top elevation view of part of a housing of a BGA electrical connector in accordance with a preferred embodiment of the present invention, showing a plurality of contacts of FIG. 1 received in the housing.

FIG. 4 is a cross-sectional view of the housing of FIG. 3 taken along line IV-IV thereof, also showing a bottom solder portion of a contact in the housing connected with a PCB via a solder ball, and an electrical package above the housing ready to be connected with the contact.

FIG. 5 is similar to FIG. 4, but showing the electrical package connected with the contact.

FIG. 6 is a simplified, isometric view of a base of a conventional electrical connector.

FIG. 7 is an enlarged, top elevation view of part of the base of FIG. 6.

FIG. 8 is an isometric view of a conventional contact.

FIG. 9 is a top elevation view of a conventional operation carrier comprising a series of preforms of contacts of FIG. 8.

### DESCRIPTION OF THE PREFERRED EMBODIMENTS

Reference will now be made to the drawing figures to describe the present invention in detail.

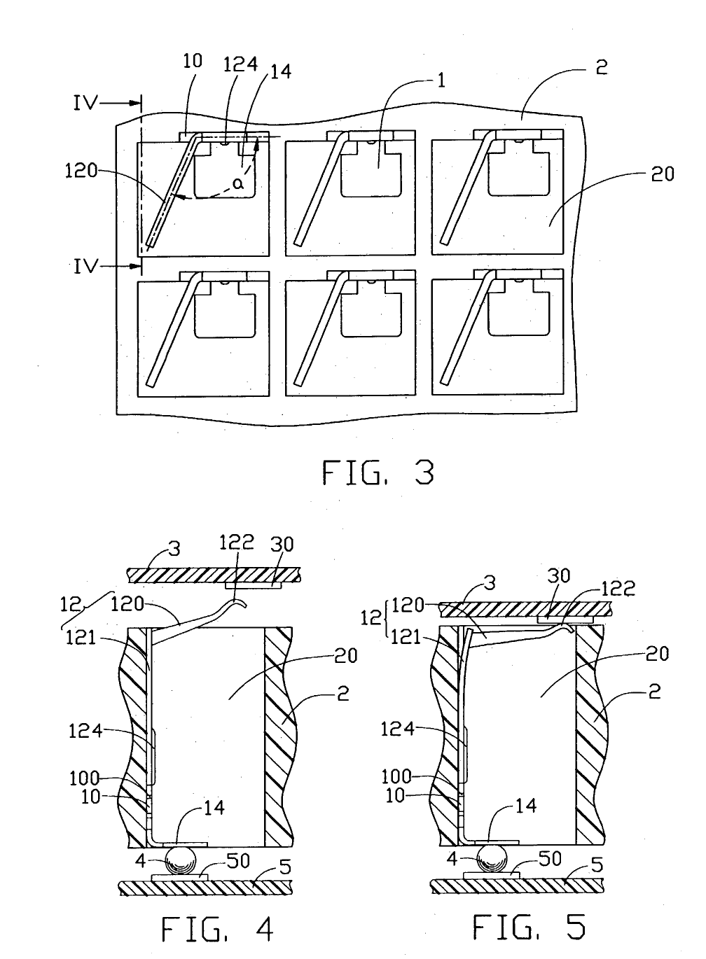

Referring to FIGS. 3 and 4, a plurality of electrical contacts 1 in accordance with a preferred embodiment of the present invention are received in an electrical connector for electrically connecting an electrical package 3 with a printed circuit board (PCB) 5. In a preferred embodiment of the present invention, the electrical connector is a ball grid array (BGA) connector. The connector comprises an insulative housing 2 defining a plurality of passageways 20, the passageways 20 being parallel to one side of the housing 2.

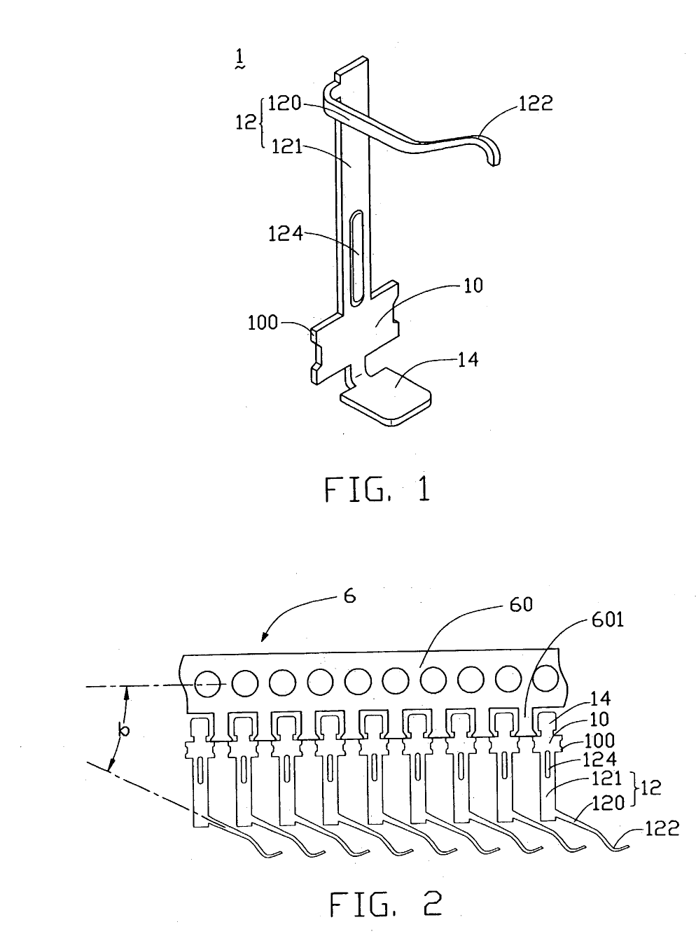

Referring also to FIG. 1, each contact 1 comprises a medial portion 10, a cantilever 12 connecting with a top end of the medial portion 10, and a solder portion 14 perpendicularly extending from an opposite bottom end of the medial portion 10. The solder portion 14 electrically connects to a conductive pad 50 of the PCB 5 via a solder ball 4 soldered on the solder portion 14. A plurality of barbs 100 extends from opposite sides of the medial portion 10, for interferentially fastening the contact 1 in a corresponding passageway 20 of the housing 2. The cantilever 12 comprises a body portion 121 extending upwardly from the medial portion 10, and an arm portion 120 extending obliquely from a distal end of the body portion 121. An obtuse angle α is defined between the medial portion 10 and the arm portion 120 (see FIG. 3). An arcuate contact portion 122 is defined at a distal end of the arm portion 120, for electrically connecting with a conductive pad 30 of the electrical package 3. A rib 124 is formed along a length of the body portion 121, for reinforcing the cantilever 12.

Referring also to FIG. 2, a carrier strip 6 comprises an operation carrier 60 connected with a series of preforms of the contacts 1 by a series of interposing connecting portions 601. The arm portion 120 of the cantilever 12 of each preform extends obliquely from one side edge of a distal end of the body portion 121. An oblique angle β is defined between the operation carrier 60 and the arm portion 120. The arm portion 120 extends beyond a distal end of the body portion 121 of an adjacent perform. In addition, the arm portions 120 of adjacent preforms are substantially parallel to each other. Thus a length of each arm portion 120 is not restricted by a proximity of the body portion 121 of the adjacent preform, and is not restricted by configurations of arm portions 120 of adjacent preforms. Accordingly, the arm portions 120 can be configured to any suitable length to provide desired elasticity thereof.

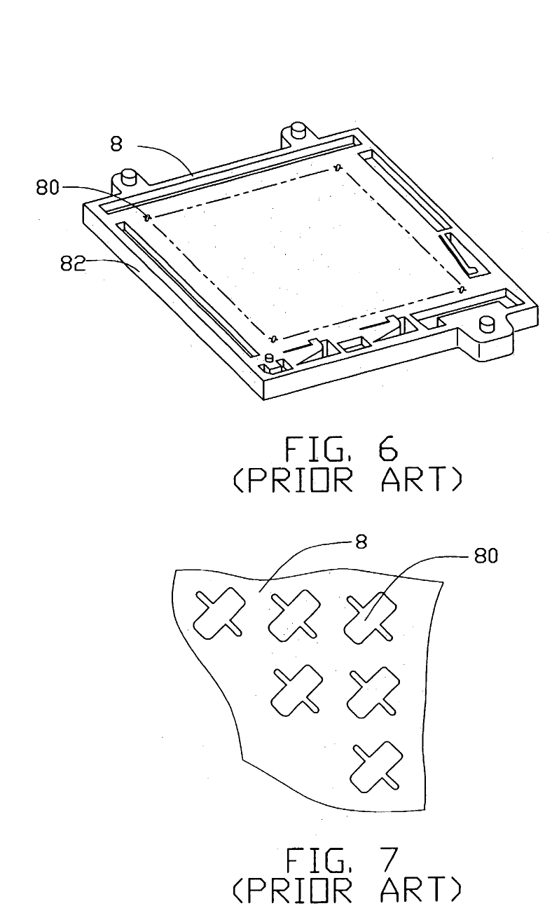

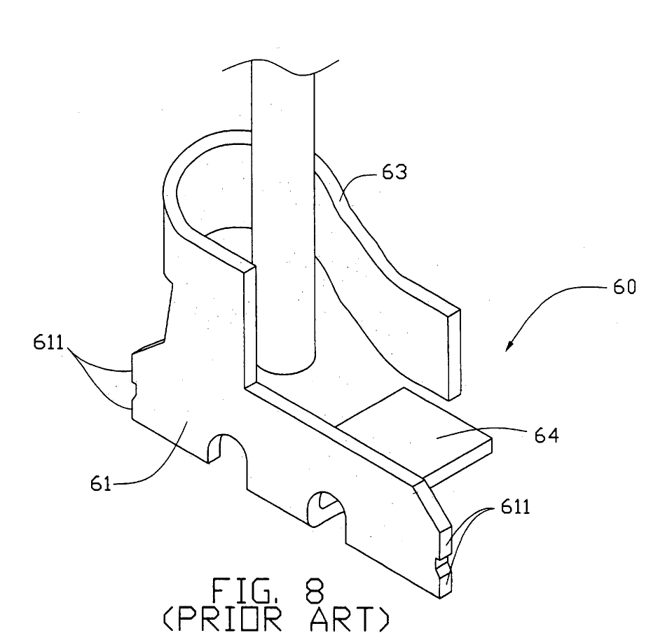

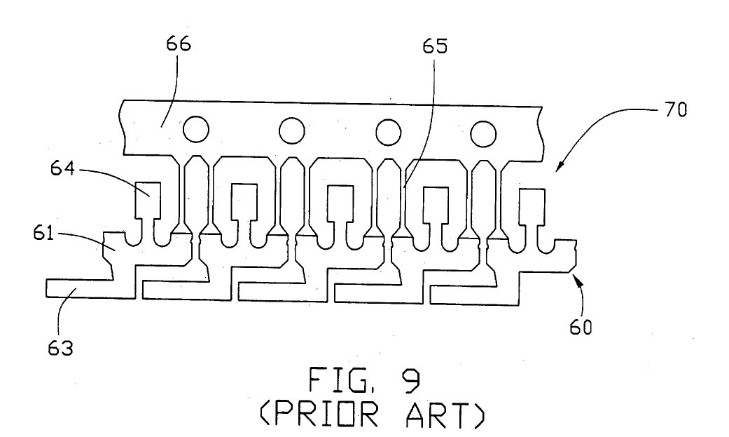

Referring to FIGS. 4 and 5, each contact 1 is received in the housing 2 of the connector. Before the contact 1 is connected to the electrical package 3, the body portion 121 extends coplanarly from the medial portion 10, and the arm portion substantially protrudes out from the receiving hole 20 of the housing 2. When the electrical package 3 is driven down by externally applied force, the conductive pad 30 presses the contact portion 122 and causes the arm portion 120 to elastically deform, which further causes a top part of the body portion 121 to elastically deform toward a middle of the passageway 20. This cooperative elastic deformation of the arm portion 120 with the body portion 121 provides the cantilever 12 with excellent elasticity.

While the present invention has been described with reference to specific embodiments, the description is illustrative of the invention and is not to be construed as limiting the invention. Various modifications to the present invention can be made to the preferred embodiments by those skilled in the art without departing from the true spirit and scope of the invention as defined by the appended claims.

What is claimed is:

1. A contact for an electrical connector for electrically connecting a printed circuit board and an electrical package, the contact comprising:
a medial portion fastened in the electrical connector; and
a cantilever comprising a body portion extending upwardly from the medial portion and an arm portion extending obliquely from a distal end of the body portion away from the medial portion, an obtuse angle being defined between the arm portion and the medial portion;
wherein when the electrical connector is connected to the electrical package, the body portion and the arm portion of the contact cooperatively elastically deform.

2. The contact as described in claim 1, further comprising a solder portion extending from a distal end of the medial portion.

3. The contact as described in claim 2, wherein a contact portion is defined at a distal end of the arm portion and the contact portion is formed directly by stamping from the conductive material.

4. The contact as described in claim 1, wherein a rib is formed on the body portion.

5. An electrical connector for electrically connecting a printed circuit board with an electrical package, the connector comprising:
an insulative housing defining a plurality of passageways therein; and
a plurality of conductive contacts received in the passageways of the housing, each of the contacts comprising:
a medial portion fastened in the housing; and
a cantilever comprising a body portion extending upwardly from the medial portion and an arm portion extending obliquely from a distal end of the body portion away from the medial portion, an obtuse angle being defined between the arm portion and the medial portion; wherein
when the connector is connected to the electrical package, the body portion and the arm portion of each of the contacts cooperatively elastically deform.

6. The electrical connector as described in claim 5, wherein each of the contacts further comprises a solder portion extending from a distal end of the medial portion.

7. The electrical connector as described in claim 6, wherein a contact portion is defined at a distal end of the arm portion and the contact portion is formed directly by stamping from the conductive material.

8. The electrical connector as described in claim 5, wherein a rib is formed on the body portion.

9. An electrical contact carrier strip, comprising:
an operation carrier;
at least one contact extending from the operation carrier, the at least one contact comprising:
a medial portion connecting with the operation carrier;
a solder portion extending from one end of the medial portion; and
a cantilever extending from an opposite end of the medial portion, the cantilever comprising a body portion and an arm portion extending from the body portion,
wherein an oblique angle is defined between the operation carrier and the arm portion.

10. The carrier strip as described in claim 9, wherein the at least one contact further comprises a solder portion extending from said one end of the medial portion.

11. The carrier strip as described in claim 10, wherein a contact portion is defined at a distal end of the arm portion and the contact portion is formed directly by stamping from the conductive material.

12. The carrier strip as described in claim 9, wherein a rib is formed on the body portion.

13. A land grid array electrical connector comprising:
an insulative housing; and
a plurality of contacts arranged in the housing, each of the contacts including a medial portion and defining a first plane within which the medial portion generally resides, and a cantilever extending from the medial portion and defining a second dominant plane within which part of the cantilever generally resides;
wherein the second dominant plane forms an oblique angle relative to the first dominant plane.

14. The electrical connector as described in claim 13, wherein the second dominant plane forms an obtuse angle relative to the first dominant plane.

15. The electrical connector as described in claim 14, wherein the cantilever includes a body portion extending from one end of the medial portion and an arm portion extending obliquely from the body portion away from the medial portion.

16. The electrical connector as described in claim 15, wherein each of the contacts further includes a solder portion extending from an opposite end of the medial portion.

17. The electrical connector as described in claim 16, wherein a contact portion is defined at a distal end of the arm portion.

18. The electrical connector as described in claim 17, wherein a rib is formed on the body portion.

19. An electrical connector assembly a comprising:
a plate with conductive pads on an undersurface thereof,
an insulative housing located under said plate and defining a plurality of passageways therein;
a plurality of contacts disposed in the corresponding passageways, respectively, each of said contacts including a retaining portion fastening the contact in the passageway, a body portion extending upwardly from the retaining portion, and an arm portion extending upwardly from one edge of an upper portion of the body portion and beyond an upper face of the housing and engaged with the corresponding pad; wherein
wherein said arm resides in a first plane which is angled relative to a second plane defined by said body portion, and wherein said arm extends obliquely relative to said upper face.

20. The assembly as described in claim 19, wherein said first plane is oblique relative to the second plane.

21. The assembly as described in claim 19, wherein said body portion and said retaining portion are coplanar with each other.
